(19) United States
(12) Patent Application Publication
(10) Pub. No.: US 2008/0286408 A1
(43) Pub. Date: Nov. 20, 2008

(54) Encapsulation of a hydrophilic substance in small capsules

(75) Inventors: Georgios D. Karles, Richmond, VA (US); Shuzhong Zhuang, Richmond, VA (US); Hongwei Liu, Appleton, WI (US)

Correspondence Address: BUCHANAN, INGERSOLL & ROONEY PC, POST OFFICE BOX 1404, ALEXANDRIA, VA, 22313-1404, US

(73) Assignee: Philip Morris USA Inc., Richmond, VA (US)

(21) Appl. No.: 12/000,296

(22) Filed: Dec. 11, 2007

Related U.S. Application Data
(60) Provisional application No. 60/877,389, filed on Dec. 28, 2006.

(51) Int. Cl. A23P 1/04; A23G 3/54; A24B 13/00

(52) U.S. Cl. 426/3; 131/352

(57) ABSTRACT

Provided is a method of encapsulating a hydrophilic substance with wax. Also provided, is a method of encapsulating honey with an edible wax to create honey capsules. The method includes ejecting a droplet of the hydrophilic substance into a stream of molten wax and allowing the droplet to pass through the molten wax to enter a container of water. The wax capsule forms an oral product that may be placed in the mouth or used in conjunction with other edible or oral products.

### CROSS REFERENCE TO RELATED APPLICATION

This application claims priority under 35 U.S.C. §119(e) to U.S. provisional Application No. 60/877,389, filed on Dec. 28, 2006, the entire content of which is incorporated herein by reference.

### BACKGROUND

Flavors and other products for use in baking, oral products, candies, and other uses have commonly been encapsulated for ease of working with the enclosed flavor or product. In addition, encapsulation techniques have been employed to preserve the enclosed product.

Exemplary encapsulation methods include spray drying and extrusion techniques. These methods can be tedious and expensive. Also, these methods can be ineffective to create a uniform product that does not stick together.

In particular, when working with a wax as the encapsulating material, such problems as agglomeration, cracking, and uneven thickness of the layer can be a problem. With uneven layers comes the potential for holes or the possibility that the encapsulated product will not work as expected.

In addition, some substances such as honey are extremely viscous and are therefore difficult to work with. The honey is sticky and often leaves work surfaces and fingers messy.

Thus, there remains a need in the art for a method of encapsulating hydrophilic substances with wax. There is also a need for a method of encapsulating honey and for a honey product that is clean and simple to use.

### SUMMARY

Provided is a new method of encapsulating hydrophilic substances in wax.

In a preferred embodiment, the method of encapsulating a hydrophilic substance includes ejecting a droplet of a hydrophilic substance into a stream of a molten wax and allowing the droplet to pass through the stream of molten wax. Preferably, the stream of molten wax is above a container of water. Once the droplet has passed through the stream of molten wax, the coated droplet is allowed to enter the container of water where the coating then solidifies. The resulting capsules are later collected from the bottom of the container of water.

Also provided is a new method of encapsulating honey. The method includes ejecting droplets of honey into a stream of molten wax and allowing the droplets to pass through the stream of wax by force of gravity. The droplets then fall into a container of water where the wax layer solidifies to create honey capsules.

Also provided is an oral, tobacco product. The oral, tobacco product includes a portion of tobacco and at least one hydrophilic substance containing wax capsule. In a preferred embodiment, the hydrophilic substance is honey. The oral, tobacco product may also include flavorants, humectants, and sweeteners. In one embodiment, the oral, tobacco product is contained within a pouch that can be placed in a user's mouth.

Also provided is an oral, non-tobacco product including a portion of a botanical material and at least one hydrophilic substance containing wax capsule. The oral, non-tobacco product may also include additional flavorants and sweeteners. In one embodiment, the oral, non-tobacco product is contained within a pouch to create a pouched product that can be placed in a user's mouth.

In another embodiment, the hydrophilic substance containing wax capsule is an oral product that can be placed in the user's mouth and chewed to release the enclosed hydrophilic substance for oral enjoyment.

### BRIEF DESCRIPTION OF THE DRAWINGS

FIG. 1 is an illustration of an exemplary encapsulation method.

FIG. 2 is a cross-sectional illustration of a hydrophilic substance containing wax capsule.

FIG. 3 is an illustration of an oral, tobacco product.

FIG. 4 is an illustration of a pouched, oral tobacco product.

FIG. 5 is an illustration of an oral, non-tobacco product.

FIG. 6 is an illustration of a pouched, oral, non-tobacco product.

### DETAILED DESCRIPTION

Provided is a method of encapsulating hydrophilic substances, particularly honey. Honey is a viscous substance that can be sticky and messy to work with. By encapsulating the honey to create honey capsules, the honey becomes manageable for use. In addition, honey capsules may also protect the honey from possible oxidation, particularly if other flavors or ingredients are mixed with the honey.

In a preferred embodiment, the method includes ejecting droplets of a hydrophilic substance into a stream of molten wax to form a coating on the hydrophilic substance. Preferably, the coated hydrophilic substance is then allowed to fall through the stream of molten wax and into a container of water where the coating solidifies.

In one embodiment, the method of encapsulation creates hydrophilic substance containing capsules that may be used in oral sensorial products. Preferably, the capsules are suitable for use in products such as, without limit, herbal pouches, tobacco pouches and other tobacco products, tea bags, and other consumable products. Additionally, the capsules may be used as an ingredient for baking or cooking, or may even be consumed independently.

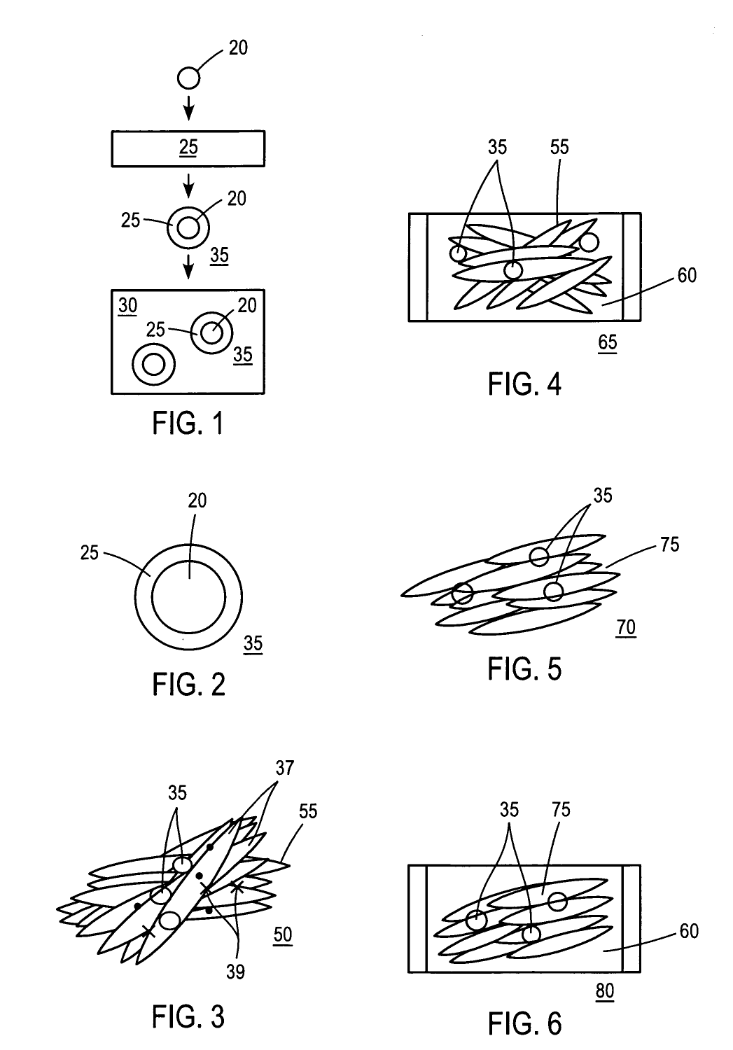

FIG. 1 shows an illustration of an exemplary encapsulation method. In an embodiment, a hydrophilic substance 20 is ejected as droplets from a location above a stream of molten wax 25. In a most preferred embodiment, the hydrophilic substance 20 is honey.

Preferably, the hydrophilic substance 20 may be ejected manually from a pipette or other apparatus. Alternatively, the process may be automated so that a nozzle ejects droplets of the hydrophilic substance 20. In an embodiment, the hydrophilic substance 20 may be ejected from any height above the stream of molten wax 25.

In a preferred embodiment, the hydrophilic substance 20 is allowed to pass through the stream of molten wax 25 in a process induced by gravity. In an embodiment, the molten wax is a natural or synthetic wax.

Suitable waxes for use in the encapsulation method include, without limitation, beeswax, carnauba wax, candelilla wax, castor wax, polyethylene waxes, petroleum based waxes, combinations thereof and the like.

Most preferably, paraffin wax is used to encapsulate the hydrophilic substance 20. Paraffin wax has a melting point of about 50° C. to about 57° C. Therefore, it is preferred that the paraffin wax used in the molten stream 25 be heated to at least about 60° C. prior to the droplets of the hydrophilic substance 20 passing through the molten stream 25. Preferably, the wax may be heated by any suitable heating method. When using other waxes, it is preferred that the wax be heated to a few degrees above the melting point for best performance.

Preferably, the weight and size of the encapsulated hydrophilic substance 20 is such that once the hydrophilic substance 20 passes through the wax 25 and into the container of water 30 the resulting capsules 35 sink to the bottom of the container. While water has a density of 1 g/cm³ and any substance having a greater density will not float on water, it is preferred that the density of the hydrophilic substance containing capsule 35 is greater than about 1.1 g/cm³ for optimum results, more preferably the density of the hydrophilic substance containing capsule 35 is greater than about 1.3 g/cm³.

In a preferred embodiment, the container of water is about 3 cm to about 5 cm below the stream of molten wax. If the container of water is too close or too far below the stream of molten wax, the coating may be destroyed.

In an embodiment, the container of water need not have any specific amount of water therein. Preferably, the water is at room temperature. Once the coated substance enters the water, the coating solidifies and the honey capsules descend to the bottom of the container where the capsules 35 may be collected.

In a preferred embodiment, the hydrophilic substance containing capsules 35 are created of a size that does not allow the capsules 35 to float on water. Preferably, the capsule 35 is about 0.1 cm to about 1.0 cm in diameter. More preferably, the capsule 35 has a diameter of about 0.5 cm. Also preferably, the capsule 35 weighs about 0.004 g to about 2.0 g (e.g. about 0.01 g to 1.0 g, about 0.1 g to 0.2 g, about 0.1 to 2.0 g, about 0.1 g to 1.5 g, about 0.5 g to 1.25 g, or about 0.75 g to 1.0 g).

In use, the capsules 35 provide controlled release of the encapsulated hydrophilic substance. Preferably, the capsule 35 must be broken to release the encapsulated honey or other hydrophilic substance. The release may occur by chewing the capsule 35 to break the wax coating 25, heating the capsule 35 until the wax coating 25 begins to melt, or any other suitable method.

Also described are oral tobacco products and oral non-tobacco products containing hydrophilic substance containing wax capsules 35.

As seen in FIG. 2, the hydrophilic substance containing wax capsule 35 includes a wax coating 25 filled with a hydrophilic substance 20. In one embodiment, the capsules 35 may be sized to deliver a single serving of the enclosed hydrophilic substance 20. Each capsule 35 could be placed in the mouth and chewed to release the hydrophilic substance 20.

In one embodiment, as seen in FIG. 3, the oral, pouchless tobacco product 50 may include a portion of tobacco material 55 optionally a binder 39, optionally a flavorant 37, and at least one hydrophilic substance containing capsule 35.

Examples of suitable types of tobacco materials 55 that may be used include, but are not limited to, flue-cured tobacco, Burley tobacco, Maryland tobacco, Oriental tobacco, rare tobacco, specialty tobacco, reconstituted tobacco, agglomerated tobacco fines, blends thereof and the like. Preferably, the tobacco material is pasteurized. Some or all of the tobacco material may be fermented.

The tobacco material 55 may be provided in any suitable form, including shreds and/or particles of tobacco lamina, processed tobacco materials, such as volume expanded or puffed tobacco, or ground tobacco, processed tobacco stems, such as cut-rolled or cut-puffed stems, reconstituted tobacco materials, blends thereof, and the like. Genetically modified tobacco may also be used.

Additionally, the tobacco material 55 may also include a supplemental amount of vegetable or plant fibers or particles such as particles of shreds of lettuce, cotton, flax, beet fiber, cellulosic fibers, blends thereof and the like.

In one embodiment, the tobacco material 55 is completely disintegrable.

Humectants can also be added to the tobacco material to help maintain the moisture levels in the portioned tobacco product. Examples of humectants that can be used with the tobacco material include glycerol, glycerine, triethylene glycol and propylene glycol. The humectants may also be provided for a preservative effect, as the water activity of the product can be decreased with inclusion of a humectant. In turn, the opportunity for growth of micro-organisms is diminished. Additionally, humectants can be used to provide a higher moisture feel to a drier tobacco component.

Suitable flavorants 37 and aromas for inclusion in the tobacco material 55 include, but are not limited to, any natural or synthetic flavor or aroma. Suitable flavors and aromas may include flavor compounds selected from the group consisting of an acid, an alcohol, an ester, and aldehyde, a ketone, a pyrazine, combinations or blends thereof and the like. Suitable flavor compounds may be selected, for example, from the group consisting of phenylacetic acid, solanone, megastimatrienone, 2-heptanone, benzylalcohol, cis-3-hexenyl acetate, valeric acid, valeric aldehyde, ester, terpene, sequiterpene, nootkatone, maltol, damascenone, pyrazine, lactone, anethole, isovaleric acid, combinations thereof and the like.

In another embodiment, as seen in FIG. 4, an oral, pouched tobacco product is provided. The pouch 60 is formed from conventional pouch materials used to create a tobacco snoose (e.g. snus) or teabag. Polymers and food grade materials may also form the pouch 60 to enclose the oral, tobacco material 55, capsules 35, and other ingredients.

A user may place the pouched, oral tobacco product 65, either with the pouch 60 or without, in his mouth and either suck or chew to release the hydrophilic substance 20 from the wax capsule 35.

In another embodiment, the capsules 35 may be used in an oral, non-tobacco product 70 as seen in FIG. 5. The oral, non-tobacco product 70 includes a non-tobacco, botanical component 75 and at least one capsule 35. In addition, flavorants and sweeteners may be added to the mixture.

Preferably, the non-tobacco, botanical component 75 is a fiber, tea, tea extract, coffee, coffee extract, fruit, fruit extract, spice, herb-like ingredients, and combinations thereof.

As seen in FIG. 6, in one embodiment, the capsules 35 are included in a pouched, oral, non-tobacco product 80. The pouched product 80 includes a pouch 60 may from conventional pouch materials. A botanical component 75 is mixed with a least one capsule 35 and enclosed in the pouch 60.

The pouched product 80 may be placed in a user's mouth and sucked or chewed to enjoy the flavors from the botanical component 75 and release the hydrophilic substance 20 from the wax coating 25 of the capsule 35.

Variations and modifications of the foregoing will be apparent to those skilled in the art. It should be recognized that productivity can be increased by using multiple nozzles and sizing the collection vessels appropriately. Also, the density of the core material could be adjusted upwards in order to facilitate precipitation of the capsules in the collection vessel through the incorporation of high density additives, such as solid powders, which can be homogenized in the liquid core. Such variations and modifications are considered within the purview and scope of the claims appended hereto.

We claim:

1. A method of encapsulating a hydrophilic substance comprising:
ejecting a droplet of a hydrophilic substance into a stream of a molten wax;
passing said droplet through said stream of a molten wax to create a wax coating; and
allowing said droplet to enter a container having a supply of water to form a hydrophilic substance containing capsule.

2. The method of claim 1, wherein said supply of water is at room temperature.

3. The method of claim 1, wherein said droplet of a hydrophilic substance is honey.

4. The method of claim 1, wherein said molten wax is selected from the group consisting of beeswax, carnauba wax, candelilla wax, castor wax, polyethylene waxes, petroleum based waxes, combinations thereof and the like.

5. The method of claim 1, wherein the density of said hydrophilic substance containing capsule is greater than about 1.1 g/cm³ or greater than about 1.3 g/cm³.

6. The method of claim 1, wherein said stream of molten wax is located about 3 cm to about 5 cm above said container having a supply of water.

7. The method of claim 1, wherein said wax coating solidifies upon contact with said supply of water.

8. The method of claim 1, wherein said hydrophilic substance containing capsule weighs about 0.004 g to about 2.0 g, about 0.1 g to about 2.0 g or about 0.1 g to about 0.2 g.

9. The method of claim 1, wherein said hydrophilic substance containing capsule has a diameter of about 0.1 cm to about 1.0 cm.

10. An oral product comprising:
at least one edible, wax capsule that contains a hydrophilic substance,
wherein said at least one hydrophilic substance containing wax capsule releases a hydrophilic substance when exposed to heat or chewing in a user's mouth.

11. The oral product of claim 10, wherein said oral product includes a fibrous, botanical material mixed with said at least one edible, wax capsule.

12. The oral product of claim 11, wherein said fibrous, botanical material is selected from the group consisting of tobacco, herbs, teas, and combinations thereof.

13. The oral product of claim 10, wherein said oral product is contained in a pouch for containing said at least one edible, wax capsule and a botanical material.

14. The oral product of claim 13, wherein said pouch is sized and configured to fit comfortably between the cheek and gum of a user's oral cavity.

15. The oral product of claim 10, wherein said hydrophilic substance is honey.

16. The oral product of claim 10, wherein said at least one edible, wax capsule includes a single serving of said hydrophilic substance.

17. The oral product of claim 10, wherein said at least one edible, wax capsule weighs about 0.004 g to 2.0 g, about 0.1 g to about 2.0 g or about 0.1 g to about 0.2 g.

18. The oral product of claim 10, wherein said at least one edible, wax capsule has a diameter of about 0.1 cm to about 1.0 cm.

19. The oral product of claim 10, wherein said at least one edible, wax capsule has a density of greater than about 1.1 g/cm³ or greater than about 1.3 g/cm³.
